(19) United States
(12) Patent Application Publication
(10) Pub. No.: US 2025/0285416 A1
(43) Pub. Date: Sep. 11, 2025

(54) MASK-BASED MEDICAL IMAGING SYSTEM

(71) Applicant: GE Precision Healthcare LLC, Waukesha, WI (US)

(72) Inventors: Pavan Annangi, Bengaluru (IN); Prasad Sudhakara Murthy, Bengaluru (IN); Harsh Suthar, Bengaluru (IN); Gopal Avinash, Concord, CA (US)

(21) Appl. No.: 19/064,883

(22) Filed: Feb. 27, 2025

(30) Foreign Application Priority Data
Mar. 6, 2024 (IN) 202441015933

(51) Int. Cl. G06V 10/774; G06V 10/25; G06V 10/26; G06V 10/98

(52) U.S. Cl. CPC G06V 10/774; G06V 10/25; G06V 10/26; G06V 10/993; G06V 2201/031

(57) ABSTRACT

Various systems and methods are presented regarding synthesizing images for application with a medical imaging system. An initial mask can be generated from one or more regions of interest (RoI) on an initial image. The one or more RoIs in the initial mask can undergo modification to create a series of conditioned masks which can be subsequently applied to the initial image to create a respective image(s) modified in accordance with the modified RoIs in the respective conditioned mask. The series of respective images can be used as frames in a cineloop. Hence, a sequence of modified images/frames can be generated from a single initial image and mask. The conditioned masks can be modified to reflect a range of healthy and unhealthy conditions. The frames/images can be utilized to train medical imaging models.

### CROSS-REFERENCE TO RELATED APPLICATIONS

This application claims priority to India Provisional Patent Application No. IN202441015933 filed on Mar. 6, 2024, entitled “MASK-BASED MEDICAL IMAGING SYSTEM”. The entireties of the aforementioned application are incorporated by reference herein.

### TECHNICAL FIELD

This application relates to systems and techniques facilitating generation of images in a biomedical imaging system.

### BACKGROUND

Artificial intelligence (AI) and machine learning (ML) technologies are finding application in medical imaging. However, the development of AI and ML enabled medical devices and clinical applications requires large amounts of labeled data, e.g., to train the AI/ML models. Further, the robustness of these technologies and techniques relies on the ability to procure and prepare training datasets covering a wide variety of patient subgroups, anatomical variations, acquisition settings, system specifications, pathological conditions, and suchlike. However, it is frequently not possible to acquire clinical data having the desired scope, particularly given medically stringent environments in which medical imaging is utilized, e.g., misdiagnosis can be the difference between effective treatment of a patient, or the patient dying.

### SUMMARY

The following presents a simplified summary of the disclosed subject matter to provide a basic understanding of one or more of the various embodiments described herein. This summary is not an extensive overview of the various embodiments. It is intended neither to identify key or critical elements of the various embodiments nor to delineate the scope of the various embodiments. The sole purpose of the Summary is to present some concepts of the disclosure in a streamlined form as a prelude to the more detailed description that is presented later.

In one or more embodiments described herein, systems, devices, computer-implemented methods, configurations, apparatus, and/or computer program products are presented to generate conditioned masks from an initial mask applied to a master image, and further modify the initial image to generate image frames, wherein the image frames are generated based on application of the conditioned masks to the initial image. In an embodiment, a conditioned mask can have a different dimension to a dimension of an initial region of interest (forming the initial mask) identified in the master image.

According to one or more embodiments, a system is presented, wherein the system comprises at least one processor, and at least one memory coupled to the at least one processor and having instructions stored thereon, wherein the system can be configured to generate a series of frames based on mask parameters applied to an initial mask generated from a master image. In response to the at least one processor executing the instructions, the instructions facilitate performance of operations, comprising: receiving an initial mask, wherein the initial mask pertains to a region in a master image. The operations can further comprise generating a series of conditioning masks based on application of a series of mask parameters to the initial mask, and further generating a series of image frames based on application of the series of conditioning masks to the master image.

In an embodiment, the initial mask can be an annotated region in the master image, wherein the annotated region denotes an organ in a body.

In another embodiment, the operations can further comprise: generating a first conditioning mask based on applying a first mask parameter to the initial mask, wherein the first mask parameter is included in the series of mask parameters. The operations can further comprise applying the first conditioning mask to the master image, wherein the first conditioning mask is included in the series of conditioning masks, and further generating a first image frame based on modification of the master image as a function of applying the first conditioning mask to the master image.

In another embodiment, the first mask parameter is one of a size of an anatomical region of the organ, a shape of the organ, or a volume of the organ.

In a further embodiment, the operations can further comprise: generating a second conditioning mask based on applying a second mask parameter to the initial mask, wherein the second mask parameter is included in the series of mask parameters. In another embodiment, the operations can further comprise applying a second conditioning mask to the master image, wherein the second conditioning mask is included in the series of conditioning masks, and further generating a second frame based on modification of the master image as a function of applying the second conditioning mask to the master image.

In another embodiment, the operations can further comprise receiving the first frame and the second frame, and further generating a cineloop comprising the first frame and the second frame.

In a further embodiment, the operations can further comprise determining a difference in image quality between the first frame and the second frame; and adjusting a first image quality of the first frame and the second image quality of the second frame to a common image quality.

In a further embodiment, the difference in image quality between the first frame and the second frame can relate to one of image exposure, image contrast, image brightness, image speckling, or other system-induced variation.

In another embodiment, the operations can further comprise determining a difference in image quality between the first frame and the second frame, further labeling the first frame with a first image quality identifier, and further labeling the second frame with a second image quality identifier.

In another embodiment, the operations can further comprise receiving an instruction regarding provisioning an image having a particular image quality, and further determining whether the first frame quality identifier matches the instruction or the second frame quality identifier matches the instruction. The operations can further comprise, in response to determining the first frame quality identifier matches the instruction, presenting the first frame, or in response to determining the second frame quality identifier matches the instruction, presenting the second frame.

In another embodiment, the master image can be a two-dimensional image or a three-dimensional image.

In further embodiments, a computer-implemented method is provided, wherein the method comprises receiving, by a device comprising at least one processor, an initial mask, wherein the initial mask is generated from at least one annotated region on a master image. The computer-implemented method can further comprise generating, by the device, a series of conditioning masks based on application of a series of mask parameters to the initial mask, wherein the series of conditioning masks comprises a first conditioning mask generated based on application of a first mask parameter to the initial mask, wherein the first mask parameter is included in the series of mask parameters, and a second conditioning mask generated based on application of a second mask parameter to the initial mask, wherein the second mask parameter is included in the series of mask parameters. The computer-implemented method can further comprise generating, by the device, a series of image frames based on application of the series of conditioning masks to the master image, wherein the series of frames includes a first frame generated based on application of the first conditioning mask to the master image, and a second frame generated based on application of the second conditioning mask to the master image.

In an embodiment, the first frame can be generated based on modification of the master image as a function of applying the first conditioning mask to the master image, and wherein the second frame can be generated based on modification of the master image as a function of applying the second conditioning mask to the master image.

In a further embodiment, the computer-implemented method can further comprise generating, by the device, a cineloop, wherein the cineloop includes the first frame and the second frame.

In a further embodiment, the computer-implemented method can further comprise determining a difference in image quality between the first frame and the second frame, and further adjusting at least one of the first frame or the second frame to reduce the difference in image quality between the first frame and the second frame, wherein the adjusting comprises modifying at least one of image exposure, image contrast, image brightness, image speckling, or other system-induced variation generated during generation of the first frame or the second frame.

In a further embodiment, the initial mask can be an annotated region in the master image, wherein the annotated region can denote an organ in a body, and wherein the first mask parameter can be one of a size of an anatomical region of the organ, a shape of the organ, or a volume of the organ.

Further embodiments can include a computer program product stored on a non-transitory computer-readable medium and comprising machine-executable instructions, wherein in response to being executed, the machine-executable instructions cause a system comprising at least one processor to perform operations, comprising: receiving an initial mask, wherein the initial mask can be generated from at least one annotated region on a master image, wherein the annotated region is a region of interest pertaining to a first organ in a body. In another embodiment, the operations can further comprise determining a feature of the first organ, wherein the feature has a measurable dimension having a first magnitude. In another embodiment, the operations can further comprise generating a series of conditioning masks based on application of a series of mask parameters to the initial mask, wherein the series of conditioning masks can include a first conditioning mask generated from a first parameter in the series of masks parameters, wherein the first parameter has a second magnitude, and wherein the second magnitude is disparate to the first magnitude, and further generating an image frame, wherein the image frame is generated based on application of the first conditioning mask to the initial image, wherein application of the first conditioning mask modifies a size of a second organ included in the initial image.

In an embodiment, the image frame is a first image frame, wherein the operations can further comprise generating a second conditioning mask generated from a second parameter in the series of masks parameters, wherein the second parameter has a third magnitude, and wherein the third magnitude is disparate to the first magnitude and the second magnitude. The operations can further comprise generating a second image frame, wherein the second image frame is generated based on application of the second conditioning mask to the initial image, wherein application of the second conditioning mask modifies the size of the second organ included in the initial image, and further generating a cineloop including the first image frame and the second image frame. In an embodiment, the measurable dimension of the feature can be one of a size of an anatomical region of the organ, a shape of the organ, or a volume of the organ.

### DESCRIPTION OF THE DRAWINGS

One or more embodiments are described below in the Detailed Description section with reference to the following drawings.

FIG. 1 presents a high-level overview of synthesizing images for a medical imaging system, in accordance with one or more embodiments.

FIG. 2 presents a collection of images generated from a series of conditioning masks, in accordance with an embodiment.

FIG. 3 presents a collection of frames being generated, wherein the frames have variation in optical quality/content, in accordance with an embodiment.

FIG. 4 illustrates an example frame generation model that can be implemented in accordance with one or more embodiments.

FIG. 5 presents a collection of images illustrating generation of a cineloop based on 2D+time (2D+t) dataset, in accordance with an embodiment.

FIG. 6 presents a collection of images illustrating generation of synthesized data from a 3D imaging process, in accordance with an embodiment.

FIG. 7 presents a collection of frames generated from conditioning masks as a function of size space parameterization, in accordance with an embodiment.

FIG. 8 presents a collection of images per an active shape space parameterization being performed, in accordance with an embodiment.

FIG. 9 presents a series of images and masks being utilized to create synthesized images as a function of parameterizing the shape space, in accordance with one or more embodiments.

FIG. 10 presents a series of synthesized videos generated from varying seed images/masks, as a function of varying texture space, in accordance with one or more embodiments.

FIG. 11 presents a computer-implemented method for utilizing masks to generate frames, images, and/or cineloop, in accordance with an embodiment.

FIG. 12 presents a computer-implemented method for utilizing masks to generate frames, images, and/or cineloop, in accordance with an embodiment.

FIG. 13 presents a computer-implemented method for utilizing masks to generate frames, images, and/or cineloop, in accordance with an embodiment.

FIG. 14 presents a computer-implemented method for utilizing masks to generate frames, images, and/or cineloop, in accordance with an embodiment.

FIG. 15 is a block diagram illustrating an example computing environment in which the various embodiments described herein can be implemented.

FIG. 16 is a block diagram illustrating an example computing environment with which the disclosed subject matter can interact, in accordance with an embodiment.

### DETAILED DESCRIPTION

The following detailed description is merely illustrative and is not intended to limit embodiments and/or application or uses of embodiments. Furthermore, there is no intention to be bound by any expressed and/or implied information presented in any of the preceding Background section and/or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It is to be understood that when an element is referred to as being “coupled” to another element, it can describe one or more different types of coupling including, but not limited to, chemical coupling, communicative coupling, electrical coupling, electromagnetic coupling, operative coupling, optical coupling, physical coupling, thermal coupling, and/or another type of coupling. Likewise, it is to be understood that when an element is referred to as being “connected” to another element, it can describe one or more different types of connecting including, but not limited to, electrical connecting, electromagnetic connecting, operative connecting, optical connecting, physical connecting, thermal connecting, and/or another type of connecting.

As used herein, “data” can comprise metadata. Further, ranges A-n and A-i are utilized herein to indicate a respective plurality of images, devices, components, signals etc., where n and i are any positive integers.

Effective training of an AI/ML model (e.g., for implementation with an automated medical imaging system) can require a plethora of data/images that capture the range of conditions the model is configured to detect, e.g., during autonomous operation. The various embodiments presented herein can be described with a high-level overview:
a) generate an initial mask (e.g., an anatomical segmentation mask) from an identified/annotated region of an initial image (e.g., of a heart and septum);
b) adjust the dimensions/shape of the initial mask to simulate the variety of conditions that can occur in a patient (e.g., healthy organ versus unhealthy organ) to create a series of conditioned masks;
c) generate a sequence of frames/images by respectively applying each of the conditioned masks to the initial image with the various organs represented in the initial image adjusting (e.g., size, volume, and suchlike) in accordance with the size/shape of the conditioned mask respectively applied to the initial image, wherein the sequence of frames cover/represent all of the anatomical/textural variation(s) of underlying an anatomical organ(s);
d) capture each of the frames; and
e) generate a sequence of frames presenting the changed organ(s) size/shape as a function of the re-dimensioned conditioned masks.

Hence, by applying a series of, for example, ten masks to the initial, single master image, a sequence of ten adjusted images are created, which can be combined to create a cineloop/video loop.

Per the various embodiments presented herein, medical images can be synthesized in a systematic manner to address variations in respective sub-spaces/semantic spaces pertinent to one or more imaging modalities presented herein. Axis of variation can include:
(i) biological variations of an organ(s) of interest, e.g.,
   (a) size of anatomical region(s),
   (b) shape and/or volume of anatomical region(s),
(ii) imaging issues, such as,
   (c) image contrast, image brightness, and
   (d) image texture (e.g., independent of the biological feature).
(iii) system/hardware variations affecting such parameters as image resolution. Variations in image texture can result from images being generated by different imaging systems and operational conditions, for example, a change in imaging frequency can lead to varying speckle size in an image. Similarly, contrast and brightness can vary across images generated by different systems/operating conditions.

Accordingly, the various embodiments presented herein can enable image processing and generation such that the resultant images can appear to be generated by a premium/state of the art system, while the original master image was generated on a more vintage system, supplied by a different vendor, and suchlike. Accordingly, the various embodiments are system agnostic.

The various embodiments are applicable to images, video sequences, datatypes/datasets for, in a non-limiting list: two-dimensional (2D) space, two-dimensional plus time (2D+t), three-dimensional (3D) space, and suchlike. Such as ultrasound images/volumes, and suchlike, pertaining to a wealth of patient conditions/pathologies.

Compared with conventional imaging systems, the various embodiments presented herein enable generation of synthetic data which can be utilized to reduce the number of datasets needed to train a robust AI model. A wide variety of images/videos can be synthesized in a systematic manner, enabling a large variation of data to be used to build robust AI models, in a fast and cheap approach to generating curated data. A technical advantage of the various embodiments presented herein can include training an AI model with less labeled or annotated data by training with synthetic data, wherein the synthetic data (e.g., modified masks, frame(s), cineloop, and the like) can be generated from original/real-world data (e.g., initial mask, master image, and the like). Accordingly, an initial mask be modified to generate a series of modified masks. The one or more embodiments presented herein can also reduce an amount of time required to train an AI model.

The AI models presented herein can utilize synthetic data to generate output that can include generated medical imaging data, such as medical images and cineloops, among others. The generated medical imaging data can be displayed and distributed across a myriad of devices. For example, displayed at a local or remote display device, transmitted to one or more remote devices, used to generate/trigger alerts and/or notifications that can be provided by, or to, local and/or remote components. For example, a modified mask(s) and/or frame(s) can be reviewed (e.g., manually or automatically), and in the event of the modified mask and/or frame, for example, exceed parameters indicating healthy structure versus unhealthy structure (e.g., size, dimension, volume, etc.), a notification can be generated based thereon.

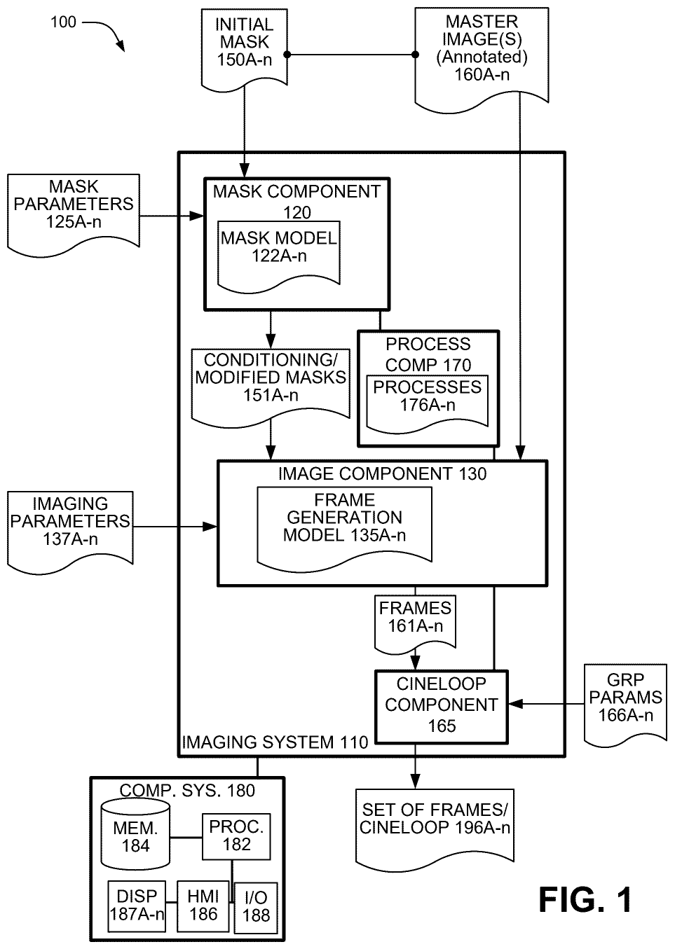

FIG. 1, system 100, presents a high-level overview of a medical imaging system for synthesizing medical images, in accordance with one or more embodiments. As shown in FIG. 1, an imaging system 110 can be configured to synthesize medical images with mask conditioned diffusion technologies/techniques, e.g., by parameterizing shape, size, texture space, and suchlike. Imaging system 110 can be configured to receive an initial/first mask 150A, wherein the initial mask 150A is generated from a master image 160A. The master image 160A can be captured from an imaging process configured to capture an image depicting an anatomical region of interest, e.g., heart, lung, brain, etc. Initial mask 150A can be generated from the master image 160A based on annotation/labelling of a region of interest (RoI) in the master image 160A. The RoI of initial mask 150A can be generated by any suitable technique/technology, e.g., by a subject matter expert(s) annotating images (e.g., using a digital pen), via supervised learning technology, by a system utilizing artificial intelligence (AI)/machine learning (ML) technologies to automatically perform digital image analysis, and suchlike, wherein annotation of the mask 150A-n can provide further ground truth information to a supervised machine learning algorithm, etc.

Imaging system 110 can comprise any suitable architecture and further include a mask component 120 configured to receive the initial mask 150A in conjunction with one or more mask generation conditions/parameters 125A-n. Mask component 120 can utilize a mask model 122A-n, wherein mask parameters 125A-n can be utilized by the mask model 122A-n to generate a set of conditioning/modified masks 151A-n. Mask parameters 125A-n can be any suitable parameter(s) such as a range of sizes, shapes, volumes, etc., across which the final frames 161A-n are generated. Mask component 120 can be communicatively coupled to process component 170, wherein the mask model 122A-n can be any suitable technique/technology in one or more processes 176A-n provided by process component 170 to perform the generation of the set of conditioning masks 151A-n. Processes 176A-n can comprise any suitable technique/technology such as deep learning, diffusion learning, an artificial neural network, a convolutional neural network, a fully convolutional network, and suchlike.

As shown, the conditioning masks 151A-n can be forwarded to image component 130, in conjunction with the master image 160A. The image component 130 can be configured to apply the set of conditioning masks 151A-n to the master image 160A, wherein each application of a conditioning mask 151A-n to the master image 160A creates a new image/frame 161A-n, with each new image/frame 161A-n generated based on the respective conditioning mask 151A-n applied to the master image 160A. For example, and as described further, in an imaging process pertaining to wall thickness of the heart septum, a first conditioning mask 151A having a first wall thickness is applied to the master image 160A to generate a first new image/frame 161A, a second conditioning mask 151B having a second wall thickness is applied to the master image 160A to generate a second new image/frame 161B, an n^{th} conditioning mask 151A having an n^{th} wall thickness is applied to the master image 160A to generate an n^{th} new image/frame 161n. The terms “frame” and “image” are used interchangeably herein regarding an image can be generated and presented in isolation or can be combined as a series of frames 161A-n in a cineloop 196A-n.

Imaging system 110 can further comprise a cineloop component 165 configured to receive and process frames 161A-n (e.g., via a process 176A-n). In an embodiment, cineloop component 165 can be configured to sequentially stitch together first new image 161A, second new image 161B, . . . n^{th} new image 161n, the set of new images 161A-n can form a video/cineloop 196A-n showing, for example, motion/size of the septum and heart cavities. Selection and combining of frames 161A-n, by cineloop component 165, can be based on grouping parameters 166A-n received at the cineloop component 165.

Hence, by generating an initial mask 150A from an initial master image 160A, adjusting the size (per mask parameters 125A-n) of the initial mask 150A to generate conditioning masks 151A-n and reapplying the conditioning masks 151A-n to the master image 160A, a series of new images 161A-n can be generated from the single, master image 160A. Further, as further described, imaging parameters 137A-n can be utilized, e.g., contrast, brightness, etc., can be applied to the frame generation model 135A-n to control generation of frames 161A-n, e.g., to a common brightness, etc.

As further shown in FIG. 1, imaging system 110 can be communicatively coupled to/include a computer system 180. Computer system 180 can include a memory 184 that stores the respective computer executable components (e.g., mask component 120, image component 130, cineloop component 165, process component 170, and suchlike, as further described herein) and further, a processor 182 configured to execute the computer executable components stored in the memory 184. Memory 184 can be further configured to store any of master image 160A, initial mask 150A-n, mask parameters 125A-n, conditioning masks 151A-n, imaging parameters 137A-n, grouping parameters 166A-n, set of images/cineloop 196A-n, frame generation model 135A-n, processes 176A-n, and suchlike.

The computer system 180 can further include a human machine interface (HMI) 186 (e.g., a display, a graphical-user interface (GUI)) which can be configured to present various information including initial mask 150A-n, master images 160A-n, mask parameters 125A-n, conditioning masks 151A-n, model 135A-n, imaging parameter(s) 137A-n, frames 161A-n, set of frames/cineloop 196A-n, vector pairings, and suchlike, per the various embodiments presented herein. HMI 186 can include an interactive display/screen 187 to present the various information. Computer system 180 can further include an I/O component 188 to receive and/or transmit respectively any of initial mask 150A-n, master images 160A-n, mask parameters 125A-n, conditioning masks 151A-n, model 135A-n, imaging parameter(s) 137A-n, frames 161A-n, grouping parameters 166A-n, set of frames/cineloop 196A-n, vector pairings, etc. Any suitable technology can be utilized for interaction/communication by I/O 188, e.g., file transfer protocol (FTP), simple radio standalone (SRS), and suchlike.

Synthetic Data Generation with Conditioning Mask

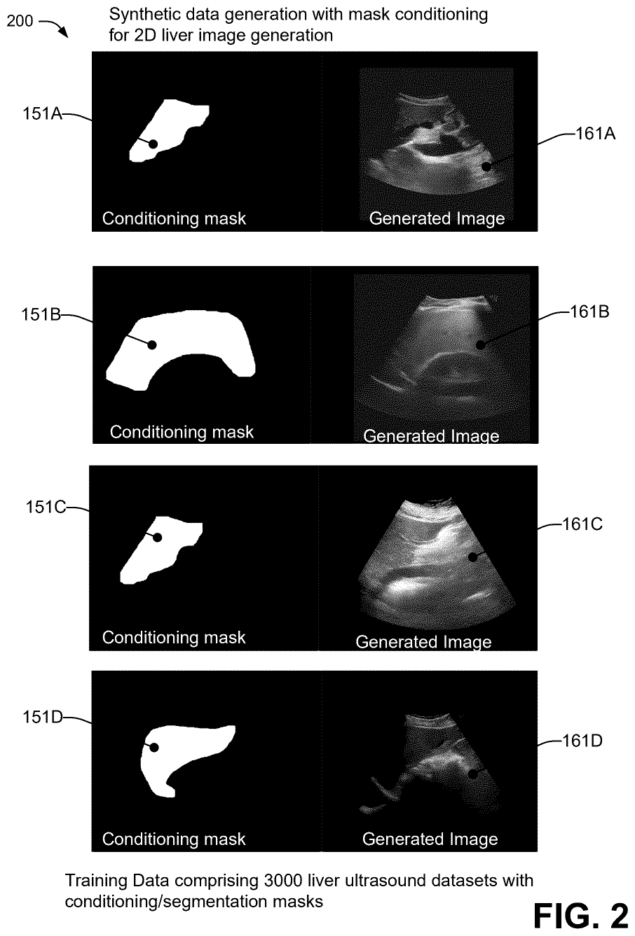

FIG. 2, collection of images 200, illustrates various images being generated from a series of conditioning masks, in accordance with an embodiment. FIG. 2 presents a series of conditioning masks 151A-n and resulting frames 161A-n after the conditioning masks 151A-n are applied to the initial image 160A. As shown, the conditioning masks 151A-n can have different profiles/shapes, with the resulting frames 161A-n generated in accordance with the particular applied conditioning mask 151A-n. In an embodiment, a conditioning mask 151A-n can comprise of a single, annotated region of interest, per the single, solid coloration of masks 151A-D in FIG. 2, such that the single region of the mask is modified.

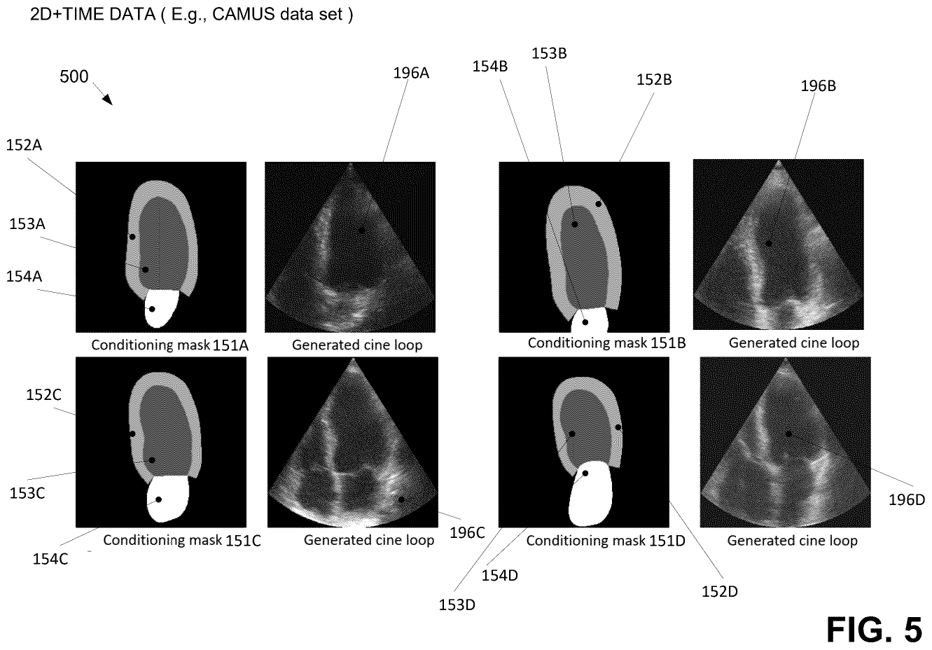

In another embodiment, a conditioning mask 151A-n can comprise of multiple regions of interest 152A-n, 153A-n, and suchlike, per FIG. 5, such that the multiple regions of interest 152A-n, 153A-n, etc., can be modified in combination or individually (e.g., regions 152A-n, 153A-n, 154A-n, etc., represent different regions/structures of a heart, heart chambers, right atrium, left atrium, right ventricle, left ventricle, valve(s), aorta, artery, organ walls, etc.) where an adjustment of a size of region 152A has an associated adjustment of regions 153A and 154A, e.g., during generation of a cineloop 196A from a single master image 160A, wherein the cineloop 196A depicts motion of the respective regions 152A-n, 153A-n, 154A-n, etc., during a heart beat cycle.

Accordingly, by applying a series of mask parameters 125A-n to an initial mask 150A/region of interest 152A (e.g., a right atrium of a heart), the mask parameters 125A-n can include a first mask parameter 125A having an initial dimension x¹ (e.g., a wall thickness of the right atrium), a second mask parameter 125B having a dimension x², a third mask parameter 125C of dimension x³, an n^{th} mask parameter 125n, etc., such that the wall thickness is adjusted on each conditioning mask 151A-n to create a series of frames 161A-n and further combine into a cineloop 196A. Hence, the sequence of frames 161A-n in the cineloop 196A can be viewed presenting a heart beating with a corresponding change in volume/shape of the right atrium and change in wall thickness of the right atrium. Further, during generation of the respective frames 161A-n, the size/position of various organs, tissue, etc., around the heart, in the master image 160A can be digitally adjusted by the image component 130 in accordance with/accommodating the size/shape of the region of interest 152A adjusting per the respective applied mask parameter 125A-n. In another example scenario, a first initial mask 150A/region of interest 152A can relate to a heart, and a second region of interest 152A relates to a left lung, such that as the respective mask parameters 125A-n are applied to create the respective conditioning masks 151A-n, and further create frames 161A-n, as the size, shape, etc., of the heart changes, the position/shape/size of the left lung changes to accommodate the changing shape/size of the heart.

### Extending Data Synthesis to 2D+t Datasets

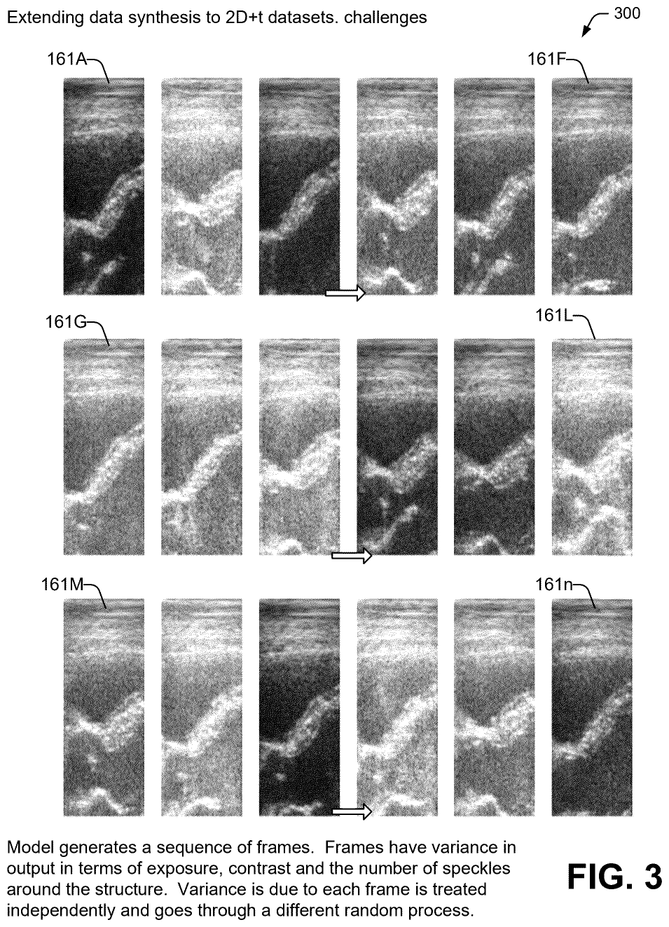

FIG. 3, collection of images 300, illustrate a sequence of frames being generated, wherein the frames have variation in optical quality/content, in accordance with an embodiment. FIG. 3 illustrates a sequences of new frames 161A-n, reading from 161A to 161n. In the event of simply instructing image component 130/model 135A-n to process a sequence of frames 161A-n and generate a cineloop 196A based thereon, the cineloop 196A can comprise frames 161A-n having inter-frame variance in terms of exposure, contrast, number of speckles around the structure of interest, and suchlike. In an aspect, the variation(s) can exist owing to each image 161A-n being generated/treated independent of other images in the set of images 161A-n, and accordingly, undergoes a different random process during generation. In an embodiment, image component 130 and frame generation model 135A-n can be configured (e.g., per imaging parameters 137A-n) to adjust generation of frames 161A-n such that frames 161A-n are generated to a common condition(s), e.g., a common contrast, brightness, etc., to enable the cineloop 196A to look visually consistent throughout.

### Mask Guided Diffusion Models for n-D Datasets

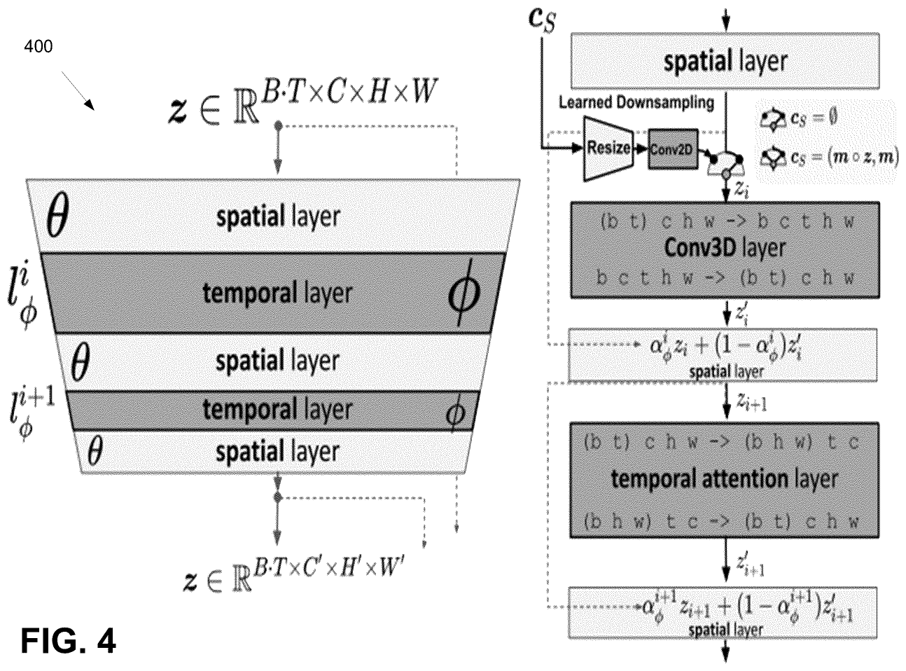

FIG. 4, schematic 400, illustrates an example frame generation model that can be implemented in accordance with one or more embodiments. As shown in FIG. 4, frame generation model 135A can comprise temporal layers incorporated into an existing denoising U-Net network. In an embodiment, the temporal layers of frame generation model 135A can be interleaved in the deepest part of U-Net after every residual block. In an example embodiment, frame generation model 135A can comprise of 2 temporal layers, such temporal layers being Conv3D and Temporal Attention, however, it is to be appreciated that processes 176A-n and models 135A-n can comprise of any suitable technique/technology.

To facilitate consistent noise across the frames 161A-n, in a model 135A-n (e.g., a diffusion model), a reverse process can be applied, comprising a Gaussian step, where the mean is predicted feeding the current time step image to the U-net. The previous time step image is given per Equations 1A and 1B:

N(xₜ₋₁;u_{θ}(xₜ,t),ε(t)) Equation 1A

Xₙ₋₁=u_{θ}(xₙ,t)+√ε(t)·N(0,1) Equation 1B

where ε is based on the schedule. Equations 1A and 1B are a reparametrized form of Gaussian distribution.

While inferencing, the highlighted term in Equation 1B xₙ₋₁=u_{θ}(xₙ,t)+√ε(t)·N(0,1), is sampled independently for every frame 161A-n in the cineloop 196A-n, which leads the model 135A-n sampling from different high data density regions and leads to varying contrast and temporal inconsistency for exposure across the frames 161A-n.

Accordingly, rather than sampling the noise N (0,1) independently for each frame 161A-n, the noise is generated once for a given timestep and that noise is the same across the frames 161A-n during denoising. Such an approach leads to images/samples in frames 161A-n being of a highly consistent nature from which a cineloop 196A-n can be created (e.g., by cineloop component 165).

### Histogram Loss

A loss term can be computed by estimating distributions of two successive frames, e.g., frame 161A and frame 161B, and enforcing the respective histograms to be similar. By utilizing the loss term, the histogram of the frames 161A-n across the loop does not vary significantly thereby ensuring consistency in respective brightness/contrast of frames 161A-n.

### 2D+Time DATA

FIG. 5, collection of images 500, illustrates generation of a cineloop based on 2D+time (2D+t) dataset, in accordance with an embodiment. The respective embodiments presented herein can be applied to 2D and 2D+t datasets, wherein, in an example application, the collection of images presented in FIG. 5 can be a CAMUS data set. The images in FIG. 5 present respective conditioning masks 151A-n having three regions of interest 152A-n, 153A-n, and 154A-n being adjusted across the sequence of conditioning masks 151A-n. FIG. 5 further illustrates frames 161A-n taken from cineloops 196A-n generated by cineloop component 165 with the conditioning masks 151A-n.

### 3D Data Synthesis

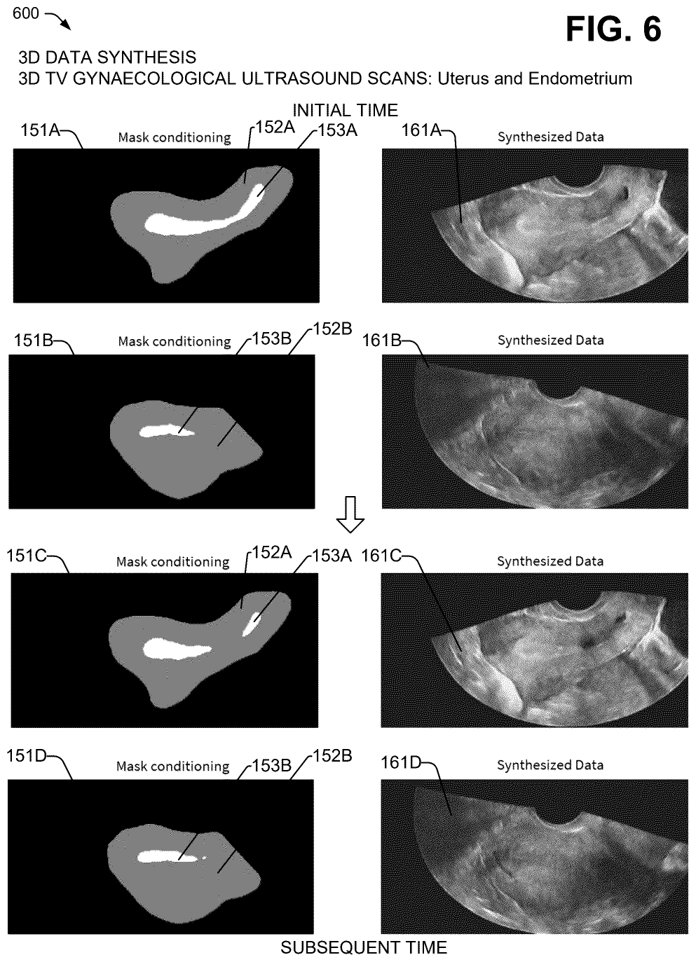

FIG. 6, collection of images 600, illustrates generation of synthesized data from a 3D imaging process, in accordance with an embodiment. FIG. 6 shows respective conditioning masks 151A-n with two annotated regions 152A-n and 153A-n being adjusted across the sequence of conditioning masks 151A-n, where regions 152A-n and 153A-n have different shapes. The respective images presented in FIG. 6 illustrate a 3D data synthesis process being conducted on 3D TV gynaecological ultrasound scans of the uterus and endometrium. FIG. 6 further illustrates synthesized data frames 161A-n taken from synthesized data cineloops 196A-n generated with the conditioning masks 151A-n. Images of masks 151A and 151B depict two conditioning masks at an initial moment, images of masks 151C and 151D depict the two conditioning masks at a subsequent moment, with frames 161A-D respectively generated therefrom, by image component 130.

### Parameterizing the Size Space

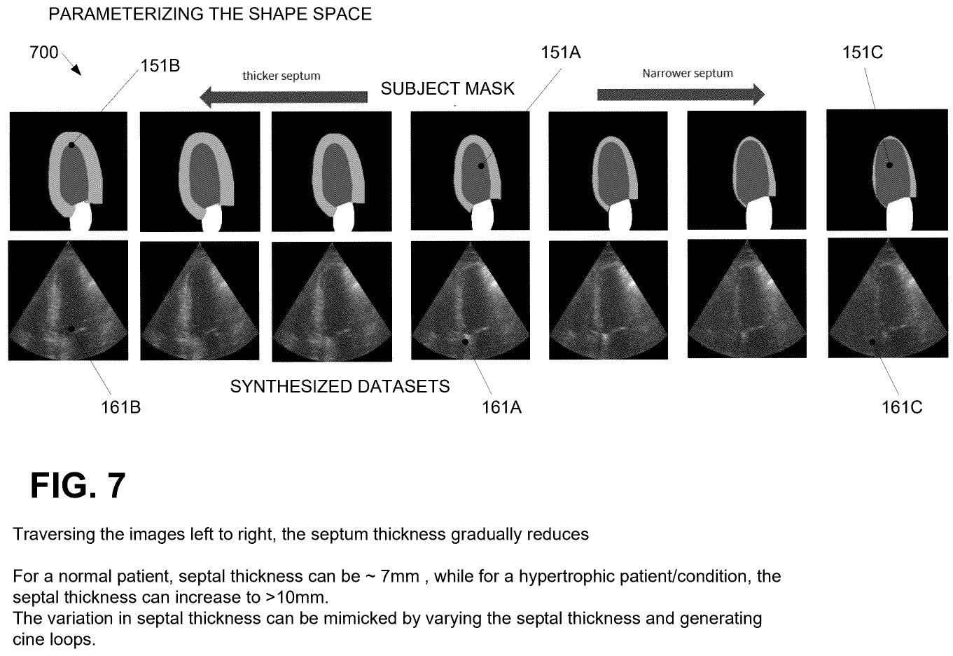

FIG. 7, collection of images 700, presents frames generated from conditioning masks as a function of size space parameterization, in accordance with an embodiment. The respective images presented in FIG. 7 pertain to septal thickness of a heart. As shown in the example frames 161A,B, C, from left to right, the septum thickness gradually reduces. For normal patients, septal thickness can be within ˜7 mm, while the septal thickness can increase to >10 mm for patients having a hypertrophic condition, for example. The variation in septal thickness is mimicked in the frames 161A-n, and resulting cineloop 191A-n, based on variation of the thickness of the septal wall in the conditioning masks 151A-n. For example, mask 151A has an initial, intermediate septal wall condition from which image 161A is generated. Based on application of a parameterization process 176N, mask 151B is generated/calculated with a thick septal wall condition from which image 161B is generated. Parameterization process 176N can be configured in accordance with mask parameters 125A-n. Based on further application of a parameterized process 176N, mask 151C is generated/calculated with a thin septal wall condition from which image 161C is generated.

Parameterizng the Shape Space: Shape Conditioning with Active Shape Model(S)

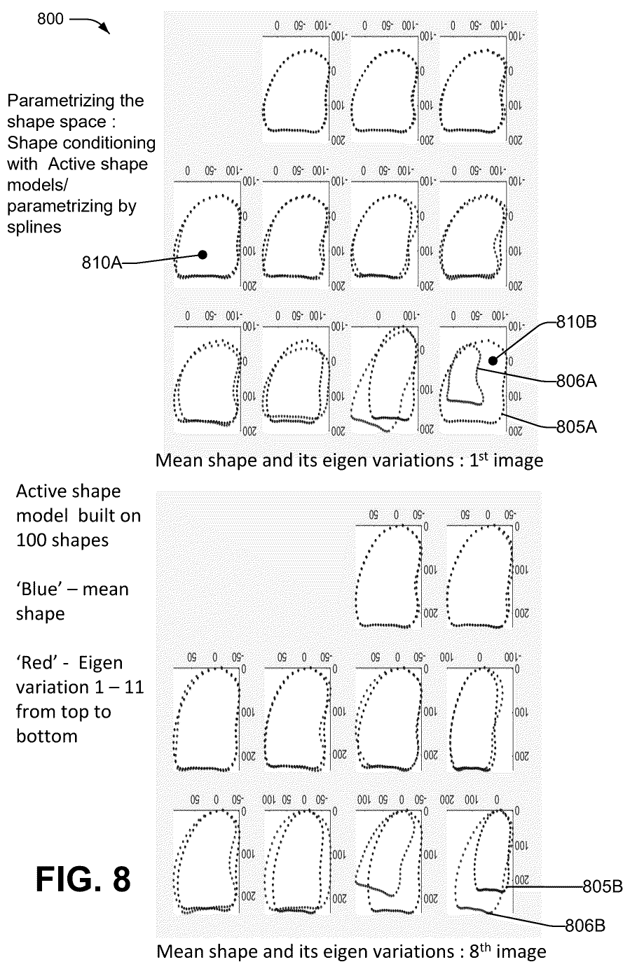

FIG. 8, collection of images 800, present active shape space parameterization being performed, in accordance with an embodiment. In an embodiment, a mean shape can be generated/computed from a collection of masks 150A-n/151A-n and corresponding collection of images 160A-n/frames 161A-n, as indicated by the blue lines 805A-n of FIG. 8, wherein the mean shape can provide a mathematical description of the shape to which new parameters/mathematical modelling can be applied (e.g., in mask parameters 125A-n). In an example embodiment, shape space parameterization can be conducted with shape conditioning using active shape models and parameterization by splines. As shown, the red lines 806A-n of FIG. 8 represent eigen variations across a respective series of active shape models and spline parameterization. Upper images present a mean shape and eigen variations generated from a first frame 161A, while the lower images present a mean shape and eigen variations generated from an eighth frame 161H. As shown, by applying different degrees of modelling/parameterization, different variations can be generated, such that image 810A results from a low degree of change/probe, while image 810B results from a greater degree of change/probe, as depicted by the respective variation in the blue lines 805A-n and red lines 806A-n.

### Parameterizing the Shape Space: Shape Conditioning by Spline Fit

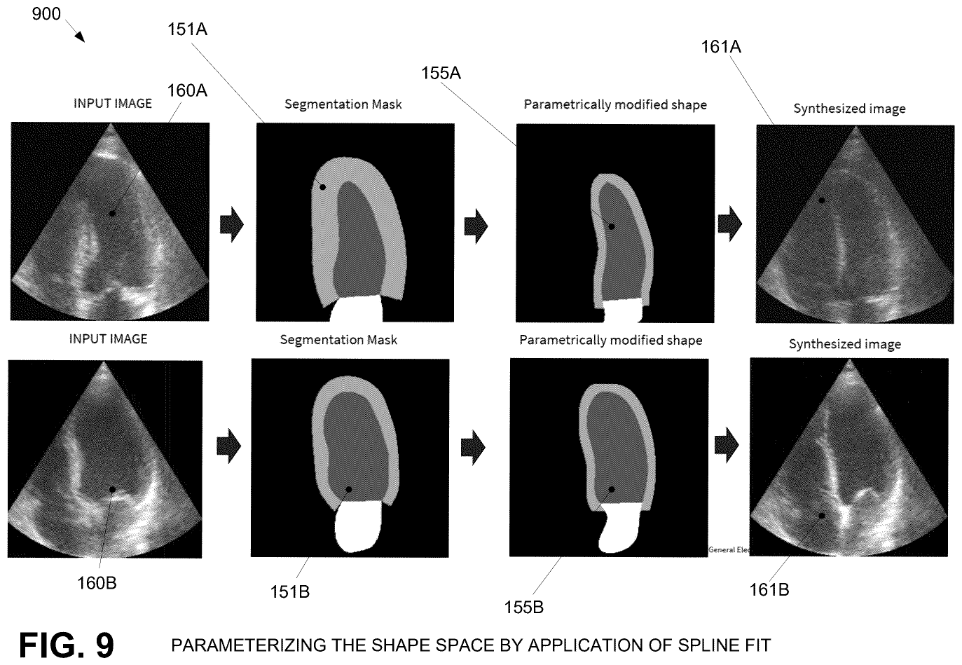

FIG. 9, image collection 900, presents a series of images and masks being utilized to create synthesized images as a function of parameterizing the shape space, in accordance with one or more embodiments. As shown, respective conditioning masks 151A and 151B are generated from initial images 160A and 160B. The conditioning masks 151A and 151B can undergo any suitable shape space processing (e.g., application of process 176S/mask parameters 125A-n being a spline curve fitting process) from which parametrically modified conditioning masks 155A and 155B are generated. The parametrically modified conditioning masks 155A and 155B can be reapplied to images 160A and 160B to generate synthesized images/frames 161A and 161B.

### Parameterizing the Texture Space

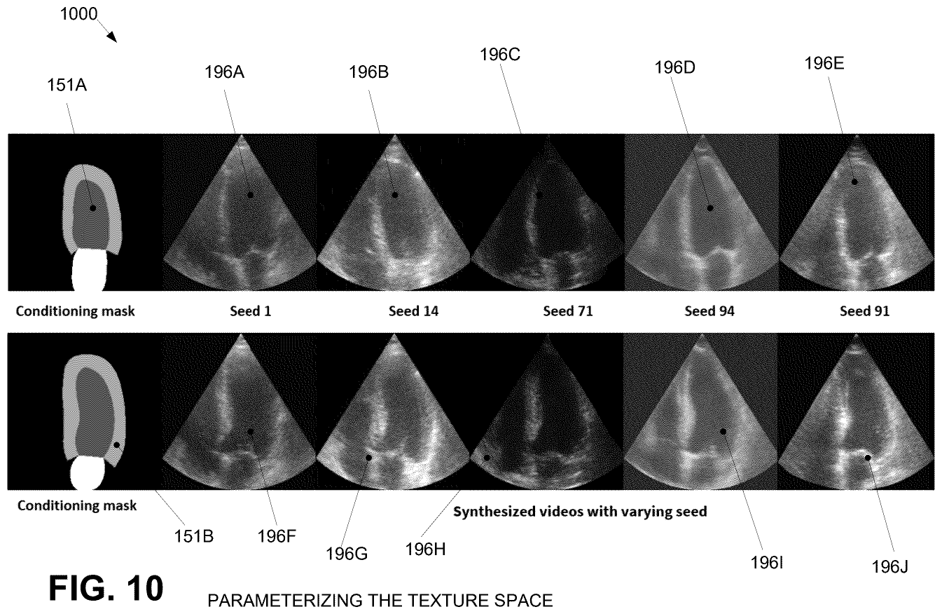

FIG. 10, image collection 1000, presents a series of synthesized videos generated from varying seed images/masks, as a function of varying texture space, in accordance with one or more embodiments. As shown, respective conditioning masks 151A and 151B can be applied to initial images 160A and 160B (as previously described), from which frames 161A-n (also referred to here as seed images) can be generated, from which cineloops 196A-n are further generated from. As previously mentioned, frames 161A-n can have various texture conditions, wherein the textures can vary across the whole set of frames 161A-n. As further previously mentioned, during generation of the frames 161A-n, the respective texture(s) can be adjusted such that a sequence of frames 161A-n have the same texture (e.g., brightness, contrast, etc.). However, in an alternative embodiment, the respective frames 161A-n can remain in an un-adjusted state. Based on the particular texture of the respective frames 161A-n, the respective frames 161A-n can be grouped and further, respective cineloops 196A-n generated having a particular texture. For example, frames 161A-n having a dark image can be grouped together, frames 161A-n having a light image can be grouped together, and suchlike. Accordingly, in response to an imaging requirement (e.g., for creation of a particular cineloop 196A) that requires a specific image quality/texture, the respective group of frames 161A-n can be identified with that specific image quality/texture (e.g., dark images, light images, contrast setting) and presented for further processing. Hence, while in one embodiment, the texture of frames 161A-n can be adjusted to a common texture (e.g., per an imaging parameter 137A-n), in another embodiment, the texture of the frames 161A-n can remain in the texture state of their creation, grouped, and processed in accordance with a desired group/texture.

In an embodiment, the respective frames 161A-n can be vectorized with regard to their image content/quality, e.g., dark image, light image, high contrast, etc., whereby the frames 161A-n can be grouped based upon performing a vector similarity process (e.g., by frame generation model 135A-n). For example, for vectors having a similar value, it can be inferred (e.g., by frame generation model 135A-n) that the associated images can be grouped together.

It is to be appreciated that while the foregoing largely relates to master images 160A-n comprising single 2D or 3D images, the various embodiments can be equally applied to a sequence of images 160A-n comprising a cineloop, video, etc., from which the initial mask(s) 150A-n are generated.

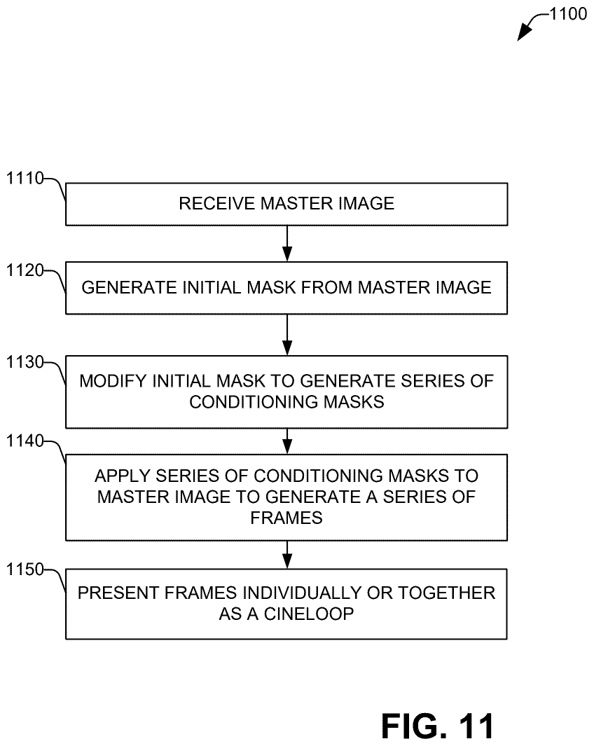

FIG. 11, flowchart 1100, presents a computer-implemented method for utilizing masks to generate frames, images, and/or cineloop, in accordance with an embodiment.

At 1110, an image (e.g., master image 160A) can be applied to an imaging system (e.g., imaging system 110), wherein the image can include one or more annotated regions of interest.

At 1120, an initial mask (e.g., initial mask 150A) can be generated based on the one or more annotated regions of interest.

At 1130, the initial mask can be applied to a mask component (e.g., mask component 120), wherein the mask component can be configured to modify the initial mask to generate a series of conditioning masks (e.g., conditioning masks 151A-n). Modification of the initial mask can be based on a series of mask parameters (mask parameters 125A-n) received at/implemented by the mask component. The mask component can utilize a mask generation process (e.g., any of suitable processes 176A-n) configured to alter/adjust/change a shape/size of a particular annotated region (e.g., regions 152A-n 153A-n, 154A-n, and suchlike) in the mask (e.g., change thickness of a septum wall across a series of masks).

At 1140, the series of conditioning masks and the master image can be applied to an image component (e.g., image component 130), wherein the image component can be configured to generate a series of frames (e.g., frames 161A-n) from the series of conditioning masks and the master image. The image component can utilize any suitable frame generation model (e.g., frame generation model 135A in processes 176A-n) to modify a copy of the master image with a respective conditioning mask, such that a first frame is generated based on application of a first conditioning mask on the master image, a second frame is generated based on application of a second conditioning mask on the master image, an n^{th} frame is generated based on application of an n^{th} conditioning mask on the master image, etc.

At 1150, the series of frames can be collected and, in an embodiment, combined to form a cineloop, wherein the cineloop can represent the sequence of frames generated from the respective instance of applying a conditioning mask to the master image. Alternatively, the respective frames in the series of frames can be presented individually.

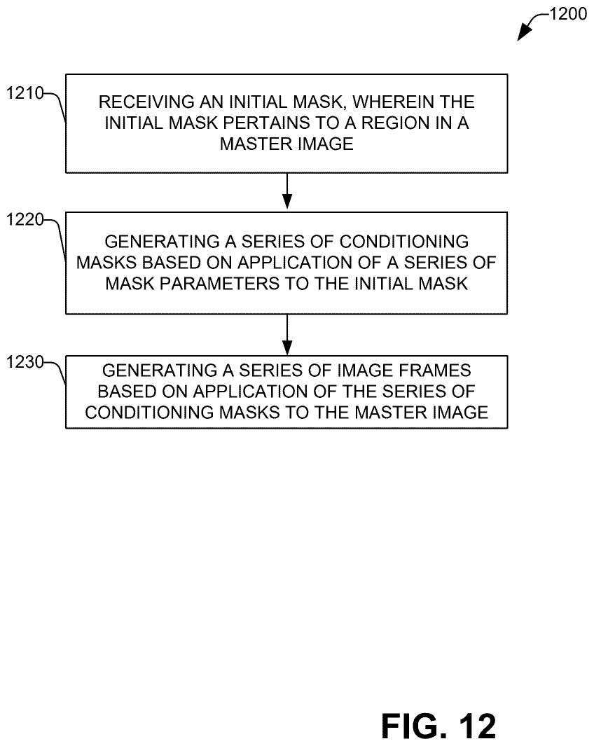

FIG. 12, via flowchart 1200, presents an example computer-implemented method for utilizing masks to generate frames, images, and/or cineloop, in accordance with an embodiment. At 1210, process 1200 can comprise a system (e.g., imaging system 110), comprising at least one processor (e.g., processor 182A) and at least one memory (e.g., memory 184A) coupled to the at least one processor and having instructions stored thereon, wherein, in response to the at least one processor executing the instructions, the instructions facilitate performance of operations, comprising receiving an initial mask (e.g., mask 150A), wherein the initial mask pertains to a region (e.g., region of interest 152A-n, 153A-n, 154A-n, etc.) in a master image (e.g., 160A).

At 1220, process 1200 can further comprise generating a series of conditioning masks (e.g., conditioning masks 151A-n) based on application of a series of mask parameters (e.g., mask parameters 125A-n) to the initial mask.

At 1230, process 1200 can further comprise generating a series of image frames (e.g., frames 161A-n) based on application of the series of conditioning masks to the master image.

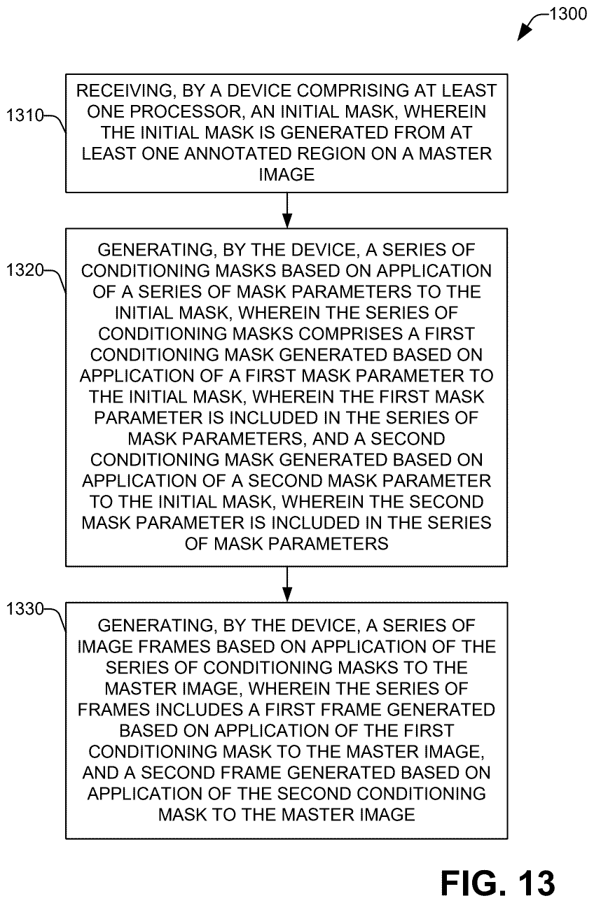

FIG. 13, via flowchart 1300, presents an example computer-implemented method for utilizing masks to generate frames, images, and/or cineloop, in accordance with an embodiment. At 1310, process 1300 can comprise receiving, by a device (e.g., imaging system 110) comprising at least one processor (e.g., processor 182A), an initial mask (e.g., initial mask 150A), wherein the initial mask is generated from an annotated region (e.g., region of interest 152A-n, 153A-n, 154A-n, etc.) on a master image (e.g., master image 160A).

At 1320, process 1300 can further comprise generating, by the device, a series of conditioning masks (e.g., conditioning masks 151A-n) based on application of a series of mask parameters (e.g., mask parameters 125A-n) to the initial mask, wherein the series of conditioning masks comprises a first conditioning mask (e.g., conditioning mask 151A) generated based on application of a first mask parameter (e.g., mask parameter 125A) to the initial mask, wherein the first mask parameter is included in the series of mask parameters, and a second conditioning mask (e.g., conditioning mask 151B) generated based on application of a second mask parameter (e.g., mask parameter 125B) to the initial mask, wherein the second mask parameter is included in the series of mask parameters.

At 1330, process 1300 can further comprise generating, by the device, a series of image frames (e.g., frames 161A-n) based on application of the series of conditioning masks to the master image, wherein the series of frames includes a first frame (e.g., frame 161A) generated based on application of the first conditioning mask to the master image, and a second frame (e.g., frame 161B) generated based on application of the second conditioning mask to the master image, wherein the series of image frames respectively depict the annotated region having a variety of dimensions (e.g., in accordance with the dimensions configured in mask parameters 125A-n).

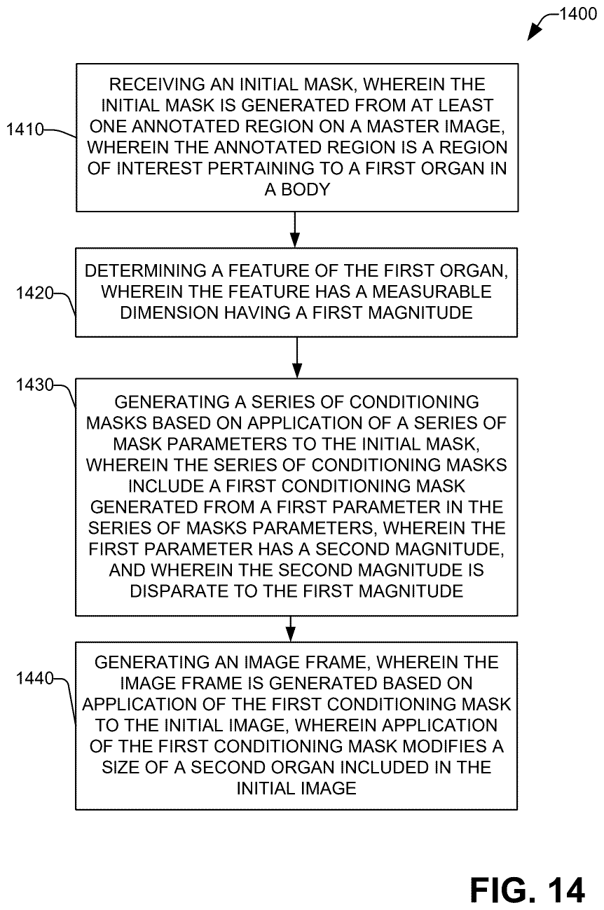

FIG. 14, via flowchart 1400, presents an example computer-implemented method for utilizing masks to generate frames, images, and/or cineloop, in accordance with an embodiment. At 1410, the process 1400 can be performed by performed by a computer program product stored on a non-transitory computer-readable medium (e.g., memory 184A) and comprising machine-executable instructions, wherein, in response to being executed (e.g., by processor 182A), the machine-executable instructions cause a system (e.g., imaging system 110) to perform operations, comprising receiving an initial mask (e.g., initial mask 150A), wherein the initial mask is generated from at least one annotated region (e.g., regions 152A-n 153A-n, 154A-n, and suchlike) on a master image (e.g., master image 160A-n), wherein the annotated region is a region of interest pertaining to a first organ (e.g., a heart) in a body.

At 1420, the process 1400 can further comprise determining a feature of the first organ, wherein the feature has a measurable dimension having a first magnitude (e.g., a heart atrium, per region of interest 152A having an internal diameter of dimension x₁).

At 1430, the process 1400 can further comprise generating a series of conditioning masks (e.g., conditioning masks 151A-n) based on application of a series of mask parameters (e.g., mask parameters 125A-n having respective dimensions x₁-Xₙ) to the initial mask, wherein the series of conditioning masks include a first conditioning mask (e.g., conditioning mask 151A) generated from a first parameter in the series of masks parameters, wherein the first parameter has a second magnitude (e.g., dimension x₂), and wherein the second magnitude is disparate to the first magnitude.

At 1440, process 1400 can further comprise generating an image frame (e.g., image frame 161A), wherein the image frame is generated based on application of the first conditioning mask to the initial image, wherein application of the first conditioning mask modifies a size of a second organ (e.g., left lung) included in the initial image.

As used herein, the terms “infer”, “inference”, “determine”, and suchlike, refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Per the various embodiments presented herein, various components included in imaging system 110, mask component 120, image component 130, cineloop component 165, process component 170, and suchlike, can include AI/ML and reasoning techniques and technologies (e.g., processes 176A-n) that employ probabilistic and/or statistical-based analysis to prognose or infer an action that a user desires to be automatically performed. The various embodiments presented herein can utilize various machine learning-based schemes for carrying out various aspects thereof. For example, a process 176A-n (e.g., by mask component 120) for automatically generating conditioning masks 151A-n based on identifying one or more regions in a master image 160A-n relating to an anatomical feature that is to be size/shape altered, for automatically generating frames 161A-n based on the applying the conditioning masks 151A-n to the master image 160A in accordance with imaging parameters 137A-n, and further automatically grouping frames 161A-n as a function of image quality, and suchlike, as previously mentioned herein, can be facilitated via an automatic classifier system and process.

A classifier is a function that maps an input attribute vector, x=(x1, x2, x3, x4, xn), to a class label class (x). The classifier can also output a confidence that the input belongs to a class, that is, f(x)=confidence (class (x)). Such classification can employ a probabilistic and/or statistical-based analysis (e.g., factoring into the analysis utilities and costs) to prognose or infer an action that a user desires to be automatically performed (e.g., generating frames 161A-n for incorporation into a cineloop 196A-n as a function of generating/applying conditioning masks 151A-n to a master image 160A, and operations related thereto).

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein is inclusive of statistical regression that is utilized to develop models of priority.

As will be readily appreciated from the subject specification, the various embodiments can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to predetermined criteria, content in master image(s) 160A-n, content of the initial mask 150A-n, effect of mask parameters 125A-n during generation of conditioning masks 151A-n, content required to generate frames 161A-n based on imaging parameters 137A-n, and content of frames 161A-n to generate collection of frames/cineloop 196A-n, for example.

As described supra, inferences can be made, and automated operations performed, based on numerous pieces of information. For example, whether sufficient context is available to infer, with a high degree of confidence, respective frames 161A-n correlating to a requirement (e.g., in grouping parameters 166A-n) to generate a cineloop 196A-n, and suchlike.

### Example Applications and Use

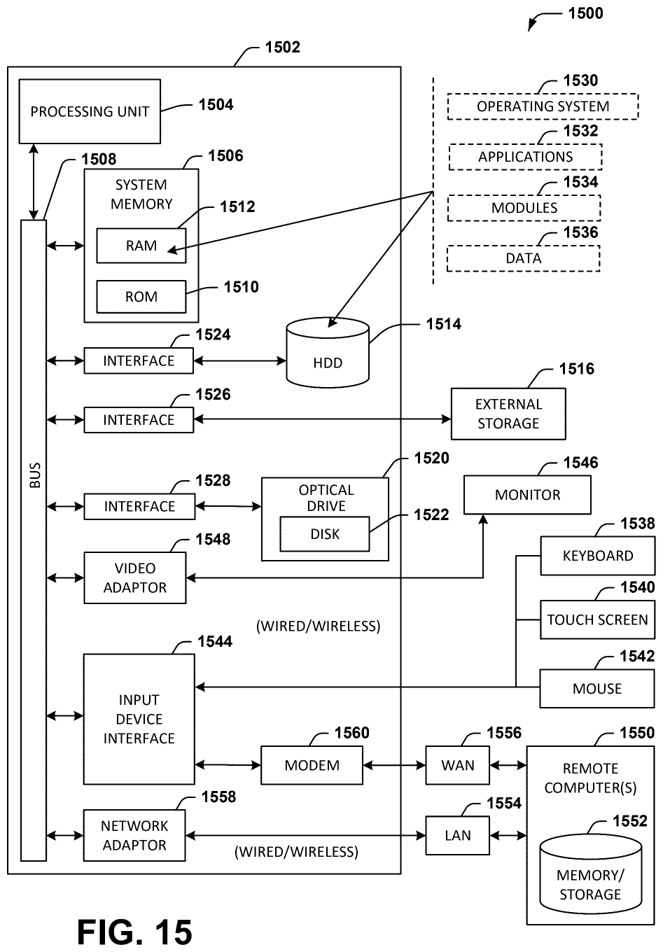

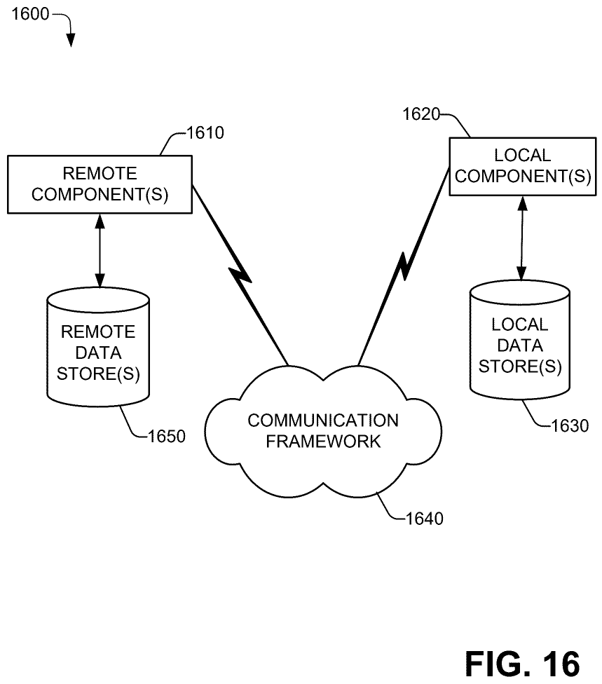

Turning next to FIGS. 15 and 16, a detailed description is provided of additional context for the one or more embodiments described herein with FIGS. 1-14.

In order to provide additional context for various embodiments described herein, FIG. 15 and the following discussion are intended to provide a brief, general description of a suitable computing environment 1500 in which the various embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 15, the example environment 1500 for implementing various embodiments of the aspects described herein includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors and may include a cache memory. Dual microprocessors and other multi-processor architectures can also be employed as the processing unit 1504.

The system bus 1508 can be any of several types of bus structure that can further interconnect to a memory bus (with or without a memory controller), a peripheral bus, and a local bus using any of a variety of commercially available bus architectures. The system memory 1506 includes ROM 1510 and RAM 1512. A basic input/output system (BIOS) can be stored in a non-volatile memory such as ROM, erasable programmable read only memory (EPROM), EEPROM, which BIOS contains the basic routines that help to transfer information between elements within the computer 1502, such as during startup. The RAM 1512 can also include a high-speed RAM such as static RAM for caching data.

The computer 1502 further includes an internal hard disk drive (HDD) 1514 (e.g., EIDE, SATA), one or more external storage devices 1516 (e.g., a magnetic floppy disk drive (FDD) 1516, a memory stick or flash drive reader, a memory card reader, etc.) and an optical disk drive 1520 (e.g., which can read or write from a CD-ROM disc, a DVD, a BD, etc.). While the internal HDD 1514 is illustrated as located within the computer 1502, the internal HDD 1514 can also be configured for external use in a suitable chassis (not shown). Additionally, while not shown in environment 1500, a solid-state drive (SSD) could be used in addition to, or in place of, an HDD 1514. The HDD 1514, external storage device(s) 1516 and optical disk drive 1522 can be connected to the system bus 1508 by an HDD interface 1524, an external storage interface 1526 and an optical drive interface 1528, respectively. The interface 1524 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1502, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. The systems and methods described herein can be implemented utilizing various commercially available operating systems or combinations of operating systems.

Computer 1502 can optionally comprise emulation technologies. For example, a hypervisor (not shown) or other intermediary can emulate a hardware environment for operating system 1530, and the emulated hardware can optionally be different from the hardware illustrated in FIG. 15. In such an embodiment, operating system 1530 can comprise one virtual machine (VM) of multiple VMs hosted at computer 1502. Furthermore, operating system 1530 can provide runtime environments, such as the Java runtime environment or the .NET framework, for applications 1532. Runtime environments are consistent execution environments that allow applications 1532 to run on any operating system that includes the runtime environment. Similarly, operating system 1530 can support containers, and applications 1532 can be in the form of containers, which are lightweight, standalone, executable packages of software that include, e.g., code, runtime, system tools, system libraries and settings for an application.

Further, computer 1502 can comprise a security module, such as a trusted processing module (TPM). For instance with a TPM, boot components hash next in time boot components, and wait for a match of results to secured values, before loading a next boot component. This process can take place at any layer in the code execution stack of computer 1502, e.g., applied at the application execution level or at the operating system (OS) kernel level, thereby enabling security at any level of code execution.

A user can enter commands and information into the computer 1502 through one or more wired/wireless input devices, e.g., a keyboard 1538, a touch screen 1540, and a pointing device, such as a mouse 1542. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1504 through an input device interface 1544 that can be coupled to the system bus 1508, but can be connected by other interfaces, such as a parallel port, an IEEE 1394 serial port, a game port, a USB port, an IR interface, a BLUETOOTH® interface, etc.

A monitor 1546 or other type of display device can be also connected to the system bus 1508 via an interface, such as a video adapter 1548. In addition to the monitor 1546, a computer typically includes other peripheral output devices (not shown), such as speakers, printers, etc.

The computer 1502 can operate in a networked environment using logical connections via wired and/or wireless communications to one or more remote computers, such as a remote computer(s) 1550. The remote computer(s) 1550 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1552 is illustrated. The logical connections depicted include wired/wireless connectivity to a local area network (LAN) 1554 and/or larger networks, e.g., a wide area network (WAN) 1556. Such LAN and WAN networking environments are commonplace in offices and companies, and facilitate enterprise-wide computer networks, such as intranets, all of which can connect to a global communications network, e.g., the internet.

When used in a LAN networking environment, the computer 1502 can be connected to the local network 1554 through a wired and/or wireless communication network interface or adapter 1558. The adapter 1558 can facilitate wired or wireless communication to the LAN 1554, which can also include a wireless access point (AP) disposed thereon for communicating with the adapter 1558 in a wireless mode.

When used in a WAN networking environment, the computer 1502 can include a modem 1560 or can be connected to a communications server on the WAN 1556 via other means for establishing communications over the WAN 1556, such as by way of the internet. The modem 1560, which can be internal or external and a wired or wireless device, can be connected to the system bus 1508 via the input device interface 1544. In a networked environment, program modules depicted relative to the computer 1502 or portions thereof, can be stored in the remote memory/storage device 1552. It will be appreciated that the network connections shown are example and other means of establishing a communications link between the computers can be used.

When used in either a LAN or WAN networking environment, the computer 1502 can access cloud storage systems or other network-based storage systems in addition to, or in place of, external storage devices 1516 as described above. Generally, a connection between the computer 1502 and a cloud storage system can be established over a LAN 1554 or WAN 1556 e.g., by the adapter 1558 or modem 1560, respectively. Upon connecting the computer 1502 to an associated cloud storage system, the external storage interface 1526 can, with the aid of the adapter 1558 and/or modem 1560, manage storage provided by the cloud storage system as it would other types of external storage. For instance, the external storage interface 1526 can be configured to provide access to cloud storage sources as if those sources were physically connected to the computer 1502.

The computer 1502 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

Referring now to details of one or more elements illustrated at FIG. 16, an illustrative cloud computing environment 1600 is depicted. FIG. 16 is a schematic block diagram of a computing environment 1600 with which the disclosed subject matter can interact. The system 1600 comprises one or more remote component(s) 1610. The remote component(s) 1610 can be hardware and/or software (e.g., threads, processes, computing devices). In some embodiments, remote component(s) 1610 can be a distributed computer system, connected to a local automatic scaling component and/or programs that use the resources of a distributed computer system, via communication framework 1640. Communication framework 1640 can comprise wired network devices, wireless network devices, mobile devices, wearable devices, radio access network devices, gateway devices, femtocell devices, servers, etc.

The system 1600 also comprises one or more local component(s) 1620. The local component(s) 1620 can be hardware and/or software (e.g., threads, processes, computing devices). In some embodiments, local component(s) 1620 can comprise an automatic scaling component and/or programs that communicate/use the remote resources 1610 and 1620, etc., connected to a remotely located distributed computing system via communication framework 1640.

One possible communication between a remote component(s) 1610 and a local component(s) 1620 can be in the form of a data packet adapted to be transmitted between two or more computer processes. Another possible communication between a remote component(s) 1610 and a local component(s) 1620 can be in the form of circuit-switched data adapted to be transmitted between two or more computer processes in radio time slots. The system 1600 comprises a communication framework 1640 that can be employed to facilitate communications between the remote component(s) 1610 and the local component(s) 1620, and can comprise an air interface, e.g., Uu interface of a UMTS network, via a long-term evolution (LTE) network, etc. Remote component(s) 1610 can be operably connected to one or more remote data store(s) 1650, such as a hard drive, solid state drive, SIM card, device memory, etc., that can be employed to store information on the remote component(s) 1610 side of communication framework 1640. Similarly, local component(s) 1620 can be operably connected to one or more local data store(s) 1630, that can be employed to store information on the local component(s) 1620 side of communication framework 1640.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” “BS transceiver,” “BS device,” “cell site,” “cell site device,” “gNode B (gNB),” “evolved Node B (eNode B, eNB),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “client entity,” “consumer,” “client entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments are described herein in the context of 5G or other next generation networks, the disclosed aspects are not limited to a 5G implementation, and can be applied in other network next generation implementations, such as sixth generation (6G), or other wireless systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), 5G, third generation partnership project 2 (3GPP2), ultra-mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology.

It is to be understood that when an element is referred to as being “coupled” to another element, it can describe one or more different types of coupling including, but not limited to, chemical coupling, communicative coupling, electrical coupling, electromagnetic coupling, operative coupling, optical coupling, physical coupling, thermal coupling, and/or another type of coupling. Likewise, it is to be understood that when an element is referred to as being “connected” to another element, it can describe one or more different types of connecting including, but not limited to, electrical connecting, electromagnetic connecting, operative connecting, optical connecting, physical connecting, thermal connecting, and/or another type of connecting.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Various non-limiting aspects of various embodiments described herein are presented in the following clauses:

Clause 1: A system, comprising: at least one processor; and at least one memory coupled to the at least one processor and having instructions stored thereon, wherein, in response to the at least one processor executing the instructions, the instructions facilitate performance of operations, comprising: receiving an initial mask, wherein the initial mask pertains to a region in a master image; generating a series of conditioning masks based on application of a series of mask parameters to the initial mask; and generating a series of image frames based on application of the series of conditioning masks to the master image.

Clause 2: The system of any preceding clause, wherein the initial mask is an annotated region in the master image, wherein the annotated region denotes an organ in a body.

Clause 3: The system of any preceding clause, wherein the operations further comprise: generating a first conditioning mask based on applying a first mask parameter to the initial mask, wherein the first mask parameter is included in the series of mask parameters; applying the first conditioning mask to the master image, wherein the first conditioning mask is included in the series of conditioning masks; and generating a first image frame based on modification of the master image as a function of applying the first conditioning mask to the master image.

Clause 4: The system of any preceding clause, wherein the first mask parameter is one of a size of an anatomical region of the organ, a shape of the organ, or a volume of the organ.

Clause 5: The system of any preceding clause, wherein the operations further comprise: generating a second conditioning mask based on applying a second mask parameter to the initial mask, wherein the second mask parameter is included in the series of mask parameters; applying a second conditioning mask to the master image, wherein the second conditioning mask is included in the series of conditioning masks; and generating a second frame based on modification of the master image as a function of applying the second conditioning mask to the master image.

Clause 6: The system of any preceding clause, wherein the operations further comprise: receiving the first frame and the second frame; and generating a cineloop comprising the first frame and the second frame.

Clause 7: The system of any preceding clause, wherein the operations further comprise: determining a difference in image quality between the first frame and the second frame; and adjusting a first image quality of the first frame and the second image quality of the second frame to a common image quality.

Clause 8: The system of any preceding clause, wherein the difference in image quality between the first frame and the second frame relates to one of image exposure, image contrast, image brightness, image speckling, or other system-induced variation.

Clause 9: The system of any preceding clause, wherein the operations further comprise: determining a difference in image quality between the first frame and the second frame; labeling the first frame with a first image quality identifier; and labeling the second frame with a second image quality identifier.

Clause 10: The system of any preceding clause, wherein the operations further comprise: receiving an instruction regarding provisioning an image having a particular image quality; determining whether the first frame quality identifier matches the instruction or the second frame quality identifier matches the instruction; and in response to determining the first frame quality identifier matches the instruction, presenting the first frame, or in response to determining the second frame quality identifier matches the instruction, presenting the second frame.

Clause 11: The system of any preceding clause, wherein the master image is a two-dimensional image or a three-dimensional image.

Clause 12: A computer-implemented method comprising: receiving, by a device comprising at least one processor, an initial mask, wherein the initial mask is generated from at least one annotated region on a master image; generating, by the device, a series of conditioning masks based on application of a series of mask parameters to the initial mask, wherein the series of conditioning masks comprises a first conditioning mask generated based on application of a first mask parameter to the initial mask, wherein the first mask parameter is included in the series of mask parameters, and a second conditioning mask generated based on application of a second mask parameter to the initial mask, wherein the second mask parameter is included in the series of mask parameters; and generating, by the device, a series of image frames based on application of the series of conditioning masks to the master image, wherein the series of frames includes a first frame generated based on application of the first conditioning mask to the master image, and a second frame generated based on application of the second conditioning mask to the master image.

Clause 13: The computer-implemented method of any preceding clause, wherein the first frame is generated based on modification of the master image as a function of applying the first conditioning mask to the master image, and wherein the second frame is generated based on modification of the master image as a function of applying the second conditioning mask to the master image.

Clause 14: The computer-implemented method of any preceding clause, further comprising: generating, by the device, a cineloop, wherein the cineloop includes the first frame and the second frame.

Clause 15: The computer-implemented method of any preceding clause, further comprising: determining a difference in image quality between the first frame and the second frame; and adjusting at least one of the first frame or the second frame to reduce the difference in image quality between the first frame and the second frame, wherein the adjusting comprises modifying at least one of image exposure, image contrast, image brightness, image speckling, or other system-induced variation generated during generation of the first frame or the second frame.

Clause 16: The computer-implemented method of any preceding clause, wherein the initial mask is an annotated region in the master image, wherein the annotated region denotes an organ in a body, and wherein the first mask parameter is one of a size of an anatomical region of the organ, a shape of the organ, or a volume of the organ.

Clause 17: A computer program product stored on a non-transitory computer-readable medium and comprising machine-executable instructions, wherein, in response to being executed, the machine-executable instructions cause a system comprising at least one processor to perform operations, comprising: receiving an initial mask, wherein the initial mask is generated from at least one annotated region on a master image, wherein the annotated region is a region of interest pertaining to a first organ in a body; determining a feature of the first organ, wherein the feature has a measurable dimension having a first magnitude; generating a series of conditioning masks based on application of a series of mask parameters to the initial mask, wherein the series of conditioning masks include a first conditioning mask generated from a first parameter in the series of masks parameters, wherein the first parameter has a second magnitude, and wherein the second magnitude is disparate to the first magnitude; and generating an image frame, wherein the image frame is generated based on application of the first conditioning mask to the initial image, wherein application of the first conditioning mask modifies a size of a second organ included in the initial image.

Clause 18: The computer program product according to any preceding clause, wherein the mask parameter is one of a size of an anatomical region of the organ, a shape of the organ, or a volume of the organ.

Clause 19: The computer program product according to any preceding clause, wherein the image frame is a first image frame, wherein the operations further comprise: generating a second conditioning mask generated from a second parameter in the series of masks parameters, wherein the second parameter has a third magnitude, and wherein the third magnitude is disparate to the first magnitude and the second magnitude; generating a second image frame, wherein the second image frame is generated based on application of the second conditioning mask to the initial image, wherein application of the second conditioning mask modifies the size of the second organ included in the initial image; and generating a cineloop including the first image frame and the second image frame.

Clause 20: The computer program product according to any preceding clause, wherein the measurable dimension of the feature is one of a size of an anatomical region of the organ, a shape of the organ, or a volume of the organ.

In various cases, any suitable combination of clauses 1-11 can be implemented.

In various cases, any suitable combination of clauses 11-16 can be implemented.

In various cases, any suitable combination of clauses 17-20 can be implemented.

What is claimed is:

1. A system, comprising:
at least one processor; and
at least one memory coupled to the at least one processor and having instructions stored thereon, wherein, in response to the at least one processor executing the instructions, the instructions facilitate performance of operations, comprising:
receiving an initial mask, wherein the initial mask pertains to a region in a master image;
generating a series of conditioning masks based on application of a series of mask parameters to the initial mask; and
generating a series of image frames based on application of the series of conditioning masks to the master image.

2. The system of claim 1, wherein the initial mask is an annotated region in the master image, wherein the annotated region denotes an organ in a body.

3. The system of claim 2, wherein the operations further comprise:
generating a first conditioning mask based on applying a first mask parameter to the initial mask, wherein the first mask parameter is included in the series of mask parameters;
applying the first conditioning mask to the master image, wherein the first conditioning mask is included in the series of conditioning masks; and
generating a first image frame based on modification of the master image as a function of applying the first conditioning mask to the master image.

4. The system of claim 3, wherein the first mask parameter is one of a size of an anatomical region of the organ, a shape of the organ, or a volume of the organ.

5. The system of claim 3, wherein the operations further comprise:
generating a second conditioning mask based on applying a second mask parameter to the initial mask, wherein the second mask parameter is included in the series of mask parameters;
applying a second conditioning mask to the master image, wherein the second conditioning mask is included in the series of conditioning masks; and
generating a second frame based on modification of the master image as a function of applying the second conditioning mask to the master image.

6. The system of claim 5, wherein the operations further comprise:
receiving the first frame and the second frame; and
generating a cineloop comprising the first frame and the second frame.

7. The system of claim 5, wherein the operations further comprise:
determining a difference in image quality between the first frame and the second frame; and
adjusting a first image quality of the first frame and the second image quality of the second frame to a common image quality.

8. The system of claim 7, wherein the difference in image quality between the first frame and the second frame relates to one of image exposure, image contrast, image brightness, image speckling, or other system-induced variation.

9. The system of claim 5, wherein the operations further comprise:
determining a difference in image quality between the first frame and the second frame;
labeling the first frame with a first image quality identifier; and
labeling the second frame with a second image quality identifier.

10. The system of claim 9, wherein the operations further comprise:
receiving an instruction regarding provisioning an image having a particular image quality;
determining whether the first frame quality identifier matches the instruction or the second frame quality identifier matches the instruction; and
in response to determining the first frame quality identifier matches the instruction, presenting the first frame, or
in response to determining the second frame quality identifier matches the instruction, presenting the second frame.

11. The system of claim 1, wherein the master image is a two-dimensional image or a three-dimensional image.

12. A computer-implemented method comprising:
receiving, by a device comprising at least one processor, an initial mask, wherein the initial mask is generated from at least one annotated region on a master image;
generating, by the device, a series of conditioning masks based on application of a series of mask parameters to the initial mask, wherein the series of conditioning masks comprises a first conditioning mask generated based on application of a first mask parameter to the initial mask, wherein the first mask parameter is included in the series of mask parameters, and a second conditioning mask generated based on application of a second mask parameter to the initial mask, wherein the second mask parameter is included in the series of mask parameters; and
generating, by the device, a series of image frames based on application of the series of conditioning masks to the master image, wherein the series of frames includes a first frame generated based on application of the first conditioning mask to the master image, and a second frame generated based on application of the second conditioning mask to the master image.

13. The computer-implemented method of claim 12, wherein the first frame is generated based on modification of the master image as a function of applying the first conditioning mask to the master image, and wherein the second frame is generated based on modification of the master image as a function of applying the second conditioning mask to the master image.

14. The computer-implemented method of claim 12, further comprising:
generating, by the device, a cineloop, wherein the cineloop includes the first frame and the second frame.

15. The computer-implemented method of claim 12, further comprising:
determining a difference in image quality between the first frame and the second frame; and
adjusting at least one of the first frame or the second frame to reduce the difference in image quality between the first frame and the second frame, wherein the adjusting comprises modifying at least one of image exposure, image contrast, image brightness, image speckling, or other system-induced variation generated during generation of the first frame or the second frame.

16. The computer-implemented method of claim 12, wherein the initial mask is an annotated region in the master image, wherein the annotated region denotes an organ in a body, and wherein the first mask parameter is one of a size of an anatomical region of the organ, a shape of the organ, or a volume of the organ.

17. A computer program product stored on a non-transitory computer-readable medium and comprising machine-executable instructions, wherein, in response to being executed, the machine-executable instructions cause a system comprising at least one processor to perform operations, comprising:
receiving an initial mask, wherein the initial mask is generated from at least one annotated region on a master image, wherein the annotated region is a region of interest pertaining to a first organ in a body;
determining a feature of the first organ, wherein the feature has a measurable dimension having a first magnitude;
generating a series of conditioning masks based on application of a series of mask parameters to the initial mask, wherein the series of conditioning masks include a first conditioning mask generated from a first parameter in the series of masks parameters, wherein the first parameter has a second magnitude, and wherein the second magnitude is disparate to the first magnitude; and
generating an image frame, wherein the image frame is generated based on application of the first conditioning mask to the initial image, wherein application of the first conditioning mask modifies a size of a second organ included in the initial image.

18. The computer program product according to claim 17, wherein the mask parameter is one of a size of an anatomical region of the organ, a shape of the organ, or a volume of the organ.

19. The computer program product according to claim 17, wherein the image frame is a first image frame, wherein the operations further comprise:
generating a second conditioning mask generated from a second parameter in the series of masks parameters, wherein the second parameter has a third magnitude, and wherein the third magnitude is disparate to the first magnitude and the second magnitude;
generating a second image frame, wherein the second image frame is generated based on application of the second conditioning mask to the initial image, wherein application of the second conditioning mask modifies the size of the second organ included in the initial image; and
generating a cineloop including the first image frame and the second image frame.

20. The computer program product according to claim 17, wherein the measurable dimension of the feature is one of a size of an anatomical region of the organ, a shape of the organ, or a volume of the organ.
